(19) United States
(12) Patent Application Publication
(10) Pub. No.: US 2004/0243409 A1
(43) Pub. Date: Dec. 2, 2004

(54) Morphological analyzer, morphological analysis method, and morphological analysis program

(75) Inventor: Tetsuji Nakagawa, Tokyo (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/812,000

(22) Filed: Mar. 30, 2004

(30) Foreign Application Priority Data
May 30, 2003 (JP) 2003-154625

(51) Int. Cl. G10L 15/12

(52) U.S. Cl. 704/240

(57) ABSTRACT

An input text is analyzed into morphemes by using a prescribed morphological analysis procedure to generate word strings with part-of-speech tags, including form information for parts of speech having forms, as hypotheses. The probabilities of occurrence of each hypothesis in a corpus of text are calculated by use of two or more part-of-speech n-gram models, at least one of which takes the forms of the parts of speech into consideration. Lexicalized models and class models may also be used. The models are weighted and the probabilities are combined according to the weights to obtain a single probability for each hypothesis. The hypothesis with the highest probability is selected as the solution to the morphological analysis. By combining multiple models, this method can resolve ambiguity with a higher degree of accuracy than methods that use only a single model.

### BACKGROUND OF THE INVENTION

1. Field of the Invention

The present invention relates to a morphological analyzer, a morphological analysis method, and a morphological analysis program, more particularly to an analyzer, method, and program that can select the best solution from a plurality of candidates with a high degree of accuracy.

2. Description of the Related Art

A morphological analyzer identifies and delimits the constituent morphemes of an input sentence, and assigns parts of speech to them. Morphological analysis often produces a plurality of candidate solutions, creating an ambiguous situation in which it is necessary to select the correct solution from among the candidates. Several methods of resolving such ambiguity by using part-of-speech n-gram models have been proposed, as described below.

A method that resolves ambiguity in Japanese morphological analysis by a stochastic approach is disclosed in Japanese Unexamined Patent Application Publication No. H7-271792. Ambiguous situations are resolved by selecting a candidate that maximizes the probability that the word string constituting a sentence and the part-of-speech string comprising the parts of speech assigned to the words will appear at the same time on the basis of part-of-speech tri-gram probabilities, which are the probability of the appearance of a third part of speech immediately preceded by given first and second parts of speech, and a part-of-speech-conditional word output probability, which is the probability of the appearance of a word with a given part of speech.

Morphological analysis with a higher degree of accuracy is realized by an extension of this method in which the parts of speech of morphemes having a distinctive property are lexicalized and parts of speech having similar properties are grouped, as disclosed by Asahara and Matsumoto in ‘Extended Statistical Model for Morphological Analysis’, Transactions of Information Processing Society of Japan (IPSJ), Vol. 43, No. 3, pp. 685-695 (2002, in Japanese).

It is difficult to perform morphological analysis with a high degree of accuracy by the method in the above patent application, because it predicts each part of speech only from the preceding part-of-speech string, and predicts word output from the sole condition of the given part of speech. A functional word such as a Japanese postposition often has a distinctive property differing from the properties of other morphemes, so for accurate analysis, lexical information as well as the part of speech should be considered. Another problem is the great number of parts of speech, several hundred or more, that must be dealt with in some part-of-speech classification systems, leading to such a vast number of combinations of parts of speech that it is difficult to apply the method in the above patent application directly to morphological analysis.

The method in the IPSJ Transactions cited above deals with morphemes having distinctive properties by lexicalizing the parts of speech, and deals with the large number of parts of speech by grouping them, but the method is error-driven. Accordingly, only some morphemes and parts of speech are lexicalized and grouped. As a result, sufficient information on morphemes is not available, and training data cannot be used effectively.

It would be desirable to have a morphological analyzer, a morphological analysis method, and a morphological analysis program that can select the best solution from a plurality of candidates with a higher degree of accuracy.

### SUMMARY OF THE INVENTION

An object of the present invention is to provide a method of morphological analysis, a morphological analyzer, and a morphological analysis program that can select the best solution from a plurality of candidates with a high degree of accuracy.

The invented method of morphological analysis applies a prescribed morphological analysis procedure to a text to generate hypotheses, each of which is a word string with part-of-speech tags, the part-of-speech tags including form information for parts of speech having forms. Next, probabilities that each hypothesis will occur in a large corpus of text are calculated by using a weighted combination of a plurality of part-of-speech n-gram models. At least one of the part-of-speech n-gram models includes information about forms of parts of speech; this model may be a hierarchical part-of-speech n-gram model. The part-of-speech n-gram models may also include one or more lexicalized part-of-speech n-gram models and one or more class n-gram models. Finally, the calculated probabilities are used to find a solution, the solution typically being the hypothesis with the highest calculated probability.

The invented method achieves improved accuracy by considering more than one part-of-speech n-gram model from the outset, and by including forms of parts of speech in the analysis.

The invention also provides a morphological analyzer having a hypothesis generator, a model storage facility, a probability calculator, and a solution finder that operate according to the invented morphological analysis method.

The invention also provides a machine-readable medium storing a program comprising computer-executable instructions for carrying out the invented morphological analysis method.

### BRIEF DESCRIPTION OF THE DRAWINGS

In the attached drawings:

FIG. 1 is a functional block diagram of a morphological analyzer according to a first embodiment of the invention;

FIG. 2 is a flowchart illustrating the operation of the first embodiment during morphological analysis;

FIG. 3 is a flowchart illustrating the model training operation of the first embodiment;

FIG. 4 is a flowchart illustrating details of the computing of weights in FIG. 3;

FIGS. 5, 6, and 7 show examples of model parameters in the first embodiment;

FIG. 8 is a functional block diagram of a morphological analyzer according to a second embodiment of the invention;

FIG. 9 is a flowchart illustrating the operation of the second embodiment during morphological analysis;

FIG. 10 is a flowchart illustrating the model training operation of the second embodiment; and

FIG. 11 is a flowchart illustrating details of the computing of weights in FIG. 10.

### DETAILED DESCRIPTION OF THE INVENTION

Embodiments of the invention will now be described with reference to the attached drawings, in which like elements are indicated by like reference characters.

### First Embodiment

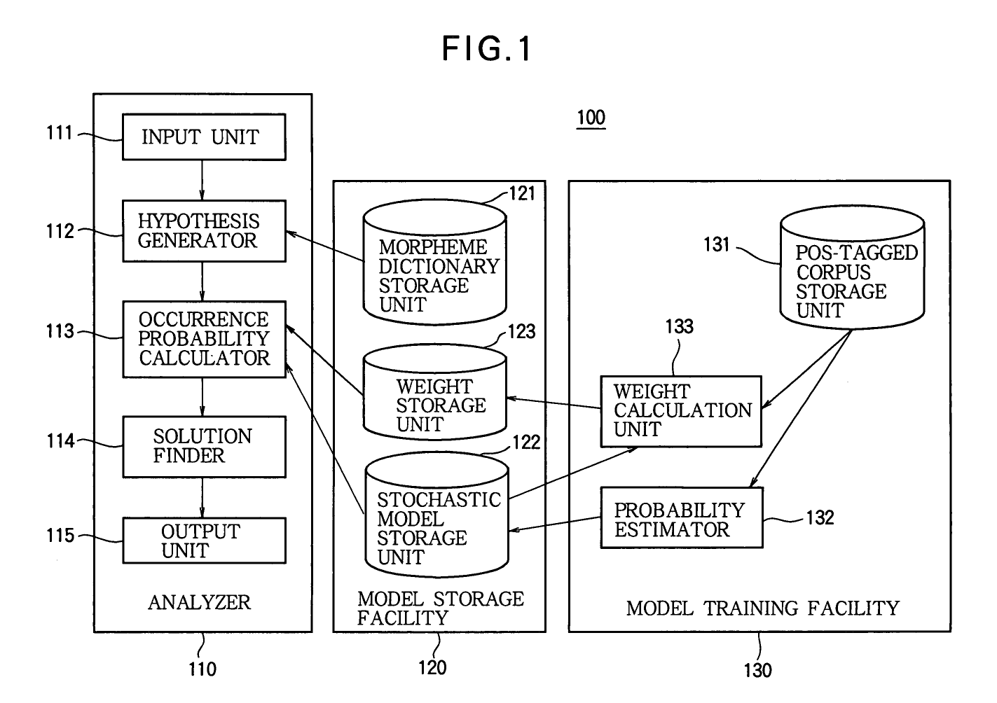

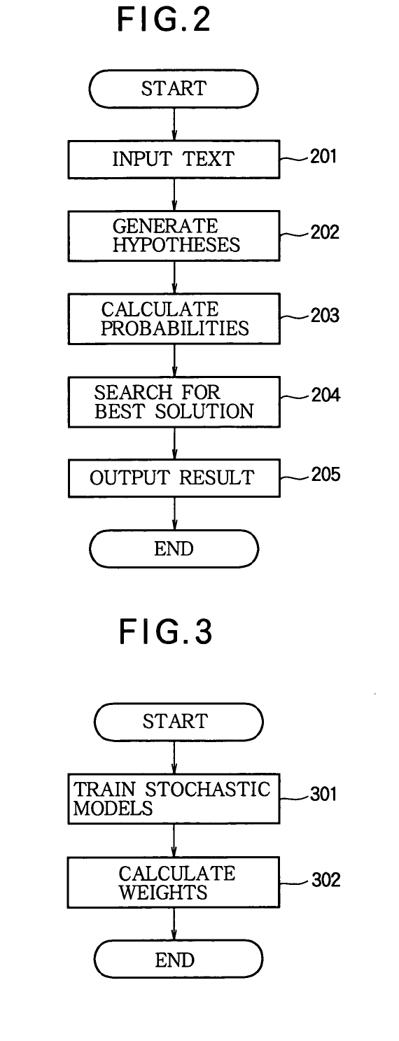

The first embodiment is a morphological analyzer that may be realized by, for example, installing a set of morphological analysis programs in an information processing device such as a personal computer. FIG. 1 shows a functional block diagram of the morphological analyzer. FIGS. 2, 3, and 4 illustrate the flow of the morphological analysis programs.

Referring to FIG. 1, the morphological analyzer 100 in the first embodiment comprises an analyzer 110 that uses stochastic models to perform morphological analysis, a model storage facility 120 that stores the stochastic models and other information, and a model training facility 130 that trains the stochastic models from a corpus of text provided for parameter training.

The analyzer 110 comprises an input unit 111 that inputs the source text on which morphological analysis is to be performed, a hypothesis generator 112 that generates possible solutions (candidate solutions or hypotheses) to the morphological analysis by using a morpheme dictionary stored in a morpheme dictionary storage unit 121, an occurrence probability calculator 113 that combines a part-of-speech n-gram model, several lexicalized part-of-speech n-gram models (defined below), and a hierarchical part-of-speech n-gram model (also defined below) stored in a stochastic model storage unit 122 by assigning weights stored in a weight storage unit 123 for the generated hypotheses and calculates probabilities of occurrence of the hypotheses, a solution finder 114 that selects the hypothesis with the maximum calculated probability as the solution to the morphological analysis, and an output unit 115 that outputs the solution obtained by the solution finder 114.

The input unit 111 may be, for example, a general-purpose input unit such as a keyboard, a file reading device such as an access device that reads a recording medium, or a character recognition device or the like, which scans a text as image data and converts it to text data. The output unit 115 may be a general-purpose output unit such as a display or a printer, or a recording medium access device or the like, which stores data in a recording medium.

The model storage facility 120 comprises the morpheme dictionary storage unit 121, the stochastic model storage unit 122, and the weight storage unit 123. The morpheme dictionary storage unit 121 stores the morpheme dictionary used by the hypothesis generator 112 for generating candidate solutions (hypotheses). The stochastic model storage unit 122 stores stochastic models that are generated by a probability estimator 132 and are used by the occurrence probability calculator 113 and a weight calculation unit 133. The weight storage unit 123 stores weights that are calculated by the weight calculation unit 133 and used by the occurrence probability calculator 113.

The model training facility 130 comprises a part-of-speech (POS) tagged corpus storage unit 131 that is used by the probability estimator 132 and the weight calculation unit 133 to train the models, the probability estimator 132, which generates the stochastic models by using the part-of-speech tagged corpus stored in the part-of-speech tagged corpus storage unit 131 and stores the results in the stochastic model storage unit 122, and the weight calculation unit 133, which calculates the weights of the stochastic models by using the stochastic models stored in the stochastic model storage unit 122 and the part-of-speech tagged corpus stored in the part-of-speech tagged corpus storage unit 131, and stores the results in the weight storage unit 123.

Next, the morphological analysis method in the first embodiment will be described by describing the general operation of the morphological analyzer 100 with reference to the flowchart in FIG. 2, which indicates the procedure by which the morphological analyzer 100 performs morphological analysis on an input text and outputs a result.

The input unit 111 receives the source text, input by a user, on which morphological analysis is to be performed (201). The hypothesis generator 112 generates hypotheses as candidate solutions to the analysis of the input source text by using the morpheme dictionary stored in the morpheme dictionary storage unit 121 (202). A general morphological analysis method, for example, is applied to this process by the hypothesis generator 112. The occurrence probability calculator 113 calculates probabilities for the hypotheses generated in the hypothesis generator 112 by using information stored in the stochastic model storage unit 122 and the weight storage unit 123 (203). To calculate the occurrence probabilities of the hypotheses, the occurrence probability calculator 113 calculates stochastically weighted probabilities of part-of-speech n-grams, lexicalized part-of-speech n-grams, and hierarchical part-of-speech n-grams.

In the following discussion, the input sentence has n words (morphemes), where n is a positive integer, the word in the (i+1)-th position from the beginning is ‘wᵢ’, and its part-of-speech tag is ‘tᵢ’. The part-of-speech tag t comprises a part of speech t^{POS} and a form t^{form}. If a part of speech has no form, the part of speech and-its part-of-speech tag are the same. Hypotheses, that is, word and part-of-speech tag strings of candidate solutions, are expressed as follows.

w₀t₀ . . . wₙ₋₁tₙ₋₁

Since the hypothesis with the highest probability should be selected as the solution, the best word/part-of-speech tag string satisfying equation (1) below must be found.

For example, two hypothetical word/part-of-speech tag strings are generated for the Japanese sentence ‘Watashi wa mita.’: one word/part-of-speech tag string is ‘watashi (noun, or pronoun if the part of speech is further subdivided) wa (postposition, or particle if the part of speech is further subdivided) mi (infinitive form of verb) ta (auxiliary verb) . (punctuation mark)’, and another word/part-of-speech tag string is ‘watashi (noun) wa (postposition) mi (dictionary form of verb) ta (auxiliary verb). (punctuation mark)’. The best solution among these two hypotheses is found from the equation (1) below. In this case, the part-of-speech tag of the word ‘mi’ specifies ‘verb’ as the part of speech, and specifies the infinitive form or dictionary form. The part-of-speech tags of the other words (including the punctuation mark) specify only the part of speech.

$$\begin{matrix}\begin{matrix}{\hat{w}}_{0} {\hat{t}}_{0} ⋯ {\hat{w}}_{n - 1} {\hat{t}}_{n - 1} = {arg max}_{{w}_{0} {t}_{0} {⋯w}_{n - 1} {t}_{n - 1}} P ( {w}_{0} {t}_{0} ⋯ {w}_{n - 1} {t}_{n - 1} ) \\ = {arg max}_{{w}_{0} {t}_{0} {⋯w}_{n - 1} {t}_{n - 1}} {\prod }_{i = 0}^{n - 1} P ( {w}_{i} {t}_{i} \vert {w}_{0} {t}_{0} ⋯ {w}_{i - 1} {t}_{i - 1} ) \\ = {arg max}_{{w}_{0} {t}_{0} {⋯w}_{n - 1} {t}_{n - 1}} {\prod }_{i = 0}^{n - 1} {\sum }_{M ∈ M}^{} P ( M \vert {w}_{0} {t}_{0} ⋯ \\ {w}_{i - 1} {t}_{i - 1} ) P ( {w}_{i} {t}_{i} \vert {w}_{0} {t}_{0} ⋯ {w}_{i - 1} {t}_{i - 1} M )\end{matrix} & ( 1 ) \\ M = \{ {M}_{POS}^{1} , ⋯ , {M}_{POS}^{{N}_{POS}} , {M}_{lex1}^{1} , ⋯ , {M}_{lex1}^{{N}_{lex1}} , {M}_{lex2}^{1} , ⋯ , {M}_{lex2}^{{N}_{lex2}} , {M}_{lex3}^{1} , ⋯ , {M}_{lex3}^{{N}_{lex3}} , {M}_{hier}^{1} , ⋯ , {M}_{hier}^{{N}_{hier}} \} & ( 2 ) \\ {\sum }_{M ∈ M}^{} P ( M ) = 1 & ( 2.5 )\end{matrix}$$

In equation (1), the best word/part-of-speech tag string is denoted ‘\hat{ }w₀\hat{ }t₀ . . . . \hat{ }wₙ₋₁\hat{ }tₙ₋₁’ in the first line, and argmax indicates the selection of the word/part-of-speech tag string with the highest probability of occurrence P(w₀t₀ . . . wₙ₋₁tₙ₋₁) among the plurality of word/part-of-speech tag strings (hypotheses).

The probability P(w₀t₀ . . . wₙ₋₁tₙ₋₁) of occurrence of a word/part-of-speech tag string can be expressed as a product of the conditional probabilities P(wᵢtᵢ|w₀t₀ . . . wₙ₋₁tₙ₋₁) of occurrence of the word/part-of-speech tag in the (i+1)-th position in the word/part-of-speech tag string, given the preceding word/part-of-speech tags, where i varies from 0 to (n−1). Each conditional probability P(wᵢtᵢ|w₀t₀ . . . wₙ₋₁tₙ₋₁) is expressed as a sum of products of the conditional output probability P(wᵢtᵢ|w₀t₀ . . . wₙ₋₁tₙ₋₁M) of the word and its part-of-speech tag in a certain n-gram model M and the weight P(M|w₀t₀ . . . wₙ₋₁tₙ₋₁) assigned to the n-gram model M, the sum being taken over all of the models.

Information giving the output probability P(wᵢtᵢ|w₀t₀ . . . wₙ₋₁tₙ₋₁M) is stored in the stochastic model storage unit 122, and information giving the weight P(M|w₀t₀ . . . wₙ₋₁tₙ₋₁) of the n-gram model M is stored in the weight storage unit 123.

In equation (2), the roman letter M represents the set of all the models M applied to the calculation of the probability P(w₀t₀ . . . wₙ₋₁tₙ₋₁). The probabilities P(M) of the constituent models in the set M sum to unity, as shown in equation (2.5).

The subscript parameter of model M indicates the type of model: POS indicates the part-of-speech n-gram model; lex1 indicates a first lexicalized part-of-speech n-gram model; lex2 indicates a second lexicalized part-of-speech n-gram model; lex3 indicates a third lexicalized part-of-speech n-gram model; and hier indicates the hierarchical part-of-speech n-gram model. The superscript parameter of model M indicates the memory length N−1 in the model, that is, the number of the words (or part-of-speech tags) N in the n-gram.

M_{POS}^{N}: Part-of-Speech N-Gram Model

P(wᵢtᵢ|w₀t₀ . . . wᵢ₋₁tᵢ₋₁M_{POS}^{N}≡P(wᵢ|tᵢ)P(tᵢ|t_{i-N+1} . . . tᵢ₋₁) (3)

Mₗₑₓ₁^{N}, Mₗₑₓ₂^{N}, Mₗₑₓ₃^{N}: lexicalized part-of-speech N-gram model

P(wᵢtᵢ|w₀t₀ . . . wᵢ₋₁tᵢ₋₁Mₗₑₓ₁^{N})≡P(wᵢ|tᵢ)P(tᵢ|w_{i-N+1}t_{i-N+1} . . . wᵢ₋₁tᵢ₋₁) (4)

P(wᵢtᵢ|w₀t₀ . . . wᵢ₋₁tᵢ₋₁Mₗₑₓ₁^{N})≡P(wᵢtᵢ|t_{i-N+1} . . . tᵢ₋₁) (5)

P(wᵢtᵢ|w₀t₀ . . . wᵢ₋₁tᵢ₋₁Mₗₑₓ^{N})≡P(wᵢtᵢ|w_{i-N+1}t_{i-N+1} . . . wᵢ₋₁tᵢ₋₁) (6)

Mₕᵢₑᵣ^{N}: hierarchical part-of-speech N-gram model

P(wᵢtᵢ|w₀t₀ . . . wᵢ₋₁tᵢ₋₁Mₕᵢₑᵣ^{N})≡P(wᵢ|tᵢ)P(tᵢ^{form}|tᵢ^{POS})P(tᵢ^{POS}|t_{i-N+1} . . . tᵢ₋₁) (7)

The POS n-gram model with memory length N−1 is defined in equation (3). This model calculates the product of the conditional probability P(wᵢ|tᵢ) of occurrence of the word wᵢ, given its part-of-speech tag tᵢ, and the conditional probability P(tᵢ|t_{i-N+1} . . . tᵢ₋₁) of occurrence of this part-of-speech tag tᵢ following the tag string t_{i-N+1} . . . tᵢ₋₁ of the parts of speech of the preceding N−1 words.

The first lexicalized part-of-speech n-gram model with memory length N−1 is defined in equation (4). This lexicalized model calculates the product of the conditional probability P(wᵢ|tᵢ) of occurrence of the word wᵢ, given its the part-of-speech tag tᵢ, and the conditional probability P(tᵢ|w_{i-N+1}t_{i-N+1} . . . wᵢ₋₁tᵢ₋₁) of occurrence of this part-of-speech tag tᵢ following the word/part-of-speech tag string of the preceding N−1 words (w_{-N+1}t_{i-N+1} . . . wᵢ₋₁tᵢ₋₁).

The second lexicalized part-of-speech n-gram model with memory length N−1 is defined in equation (5). This lexicalized model calculates the conditional probability P(wᵢtᵢ|t_{i-N+1} . . . tᵢ₋₁) of occurrence of the combination wᵢtᵢ of the word wᵢ and its part-of-speech tag tᵢ following the part-of-speech tag string t_{i-N+1} . . . tᵢ₋₁ of the preceding N−1 words.

The third lexicalized part-of-speech n-gram model with memory length N−1 is defined in equation (6). This lexicalized model calculates the conditional probability P(wᵢtᵢ|w_{i-N+1}t_{i-N+1} . . . wᵢ₋₁tᵢ₋₁) of occurrence of the combination wᵢtᵢ of the word wᵢ and its part-of-speech tag tᵢ following the word/part-of-speech tag string w_{i-N+1}t_{i-N+1} . . . wᵢ₋₁tᵢ₋₁ of the preceding N−1 words.

The hierarchical part-of-speech n-gram model with memory length N−1 is defined in equation (7). This model calculates the product of the conditional probability P(wᵢ|tᵢ) of occurrence of the word wᵢ among words having the same part of speech tᵢ, the conditional probability P(tᵢ^{form}|tᵢ^{POS}) of occurrence of the part of speech tᵢ^{pos} of word wᵢ in its form tᵢ^{form}, and the conditional probability P(tᵢ^{pos}|t_{i-N+1} . . . tᵢ₋₁) of occurrence of the part of speech tᵢ^{pos} of word wᵢ following the part-of-speech tags t_{i-N+1} . . . tᵢ₋₁ of the preceding N−1 words. If a part of speech has no forms, the conditional probability P(tᵢ^{form}|tᵢ^{pos}) of occurrence of the part of speech tᵢ^{pos} of word wᵢ in its form tᵢ^{form} is always unity.

When the probabilities P(w₀t₀ . . . wₙ₋₁tₙ₋₁) have been calculated for the hypotheses by the occurrence probability calculator 113, the solution finder 114 selects the hypothesis with the highest probability, as shown in equation (1) (204 in FIG. 2).

Although the solution finder 114 may search for the solution with the highest probability P(w₀t₀ . . . wₙ₋₁tₙ₋₁) (the best solution) after the calculation of the probabilities P for the hypotheses by the occurrence probability calculator 113 as described above, the processes performed by the occurrence probability calculator 113 and the solution finder 114 may be merged and performed by applying the Viterbi algorithm, for example. More specifically, the processes performed by the occurrence probability calculator 113 and the solution finder 114 can be merged and the best solution found by searching for the best word/part-of-speech tag string by the Viterbi algorithm while gradually increasing the parameter (i) that specifies the length of the word/part-of-speech tag string from the beginning of the input sentence to the (i+1)-th position.

When the word/part-of-speech tag string of the hypothesis satisfying equation (1) above is found, it is output to the user by the output unit 115 as the result of the morphological analysis (the best solution) (205).

Next, the operation of the model training facility 130, that is, the operations by which the conditional probabilities in the stochastic models and the weights of the stochastic models are calculated from the pre-provided part-of-speech tagged corpus for use by the occurrence probability calculator 113 will be described with reference to FIG. 3.

The probability estimator 132 trains the parameters of the stochastic models, as described below (301).

If X is a string such as a word string, a part-of-speech string, a part-of-speech tag string or a word/part-of-speech tag string, and if f(X) indicates the number of occurrences of the string X in the corpus stored in the part-of-speech tagged corpus storage unit 131, the parameters for the different stochastic models are expressed as follows.

M_{POS}^{N}: Part-of-Speech N-Gram Model

$$\begin{matrix}P ( {w}_{i} \vert {t}_{i} ) = \frac{f ( {t}_{i} {w}_{i} )}{f ( {t}_{i} )} & ( 8 ) \\ P ( {t}_{i} \vert {t}_{i - N + 1} ⋯ {t}_{i - 1} ) = \frac{f ( {t}_{i - N + 1} ⋯ {t}_{i - 1} {t}_{i} )}{f ( {t}_{i - N + 1} ⋯ {t}_{i - 1} )} & ( 9 )\end{matrix}$$

Mₗₑₓ₁^{N}, Mₗₑₓ₂^{N}, Mₗₑₓ₃^{N}: Lexicalized Part-of-Speech N-Gram Model

$$\begin{matrix}P ( {w}_{i} \vert {t}_{i} ) = \frac{f ( {t}_{i} {w}_{i} )}{f ( {t}_{i} )} & ( 10 ) \\ P ( {t}_{i} \vert {w}_{i - N + 1} {t}_{i - N + 1} ⋯ {w}_{i - 1} {t}_{i - 1} ) = \frac{f ( {w}_{i - N + 1} {t}_{i - N + 1} ⋯ {w}_{i - 1} {t}_{i - 1} {t}_{i} )}{f ( {w}_{i - N + 1} {t}_{i - N + 1} ⋯ {w}_{i - 1} {t}_{i - 1} )} & ( 11 ) \\ P ( {w}_{i} {t}_{i} \vert {t}_{i - N + 1} ⋯ {t}_{i - 1} ) = \frac{f ( {t}_{i - N + 1} ⋯ {t}_{i - 1} {w}_{i} {t}_{i} )}{f ( {t}_{i - N + 1} ⋯ {t}_{i - 1} )} & ( 12 ) \\ P ( {w}_{i} {t}_{i} \vert {w}_{i - N + 1} {t}_{i - N + 1} ⋯ {w}_{i - 1} {t}_{i - 1} ) = \frac{f ( {w}_{i - N + 1} {t}_{i - N + 1} ⋯ {w}_{i - 1} {t}_{i - 1} {w}_{i} {t}_{i} )}{f ( {w}_{i - N + 1} {t}_{i - N + 1} ⋯ {w}_{i - 1} {t}_{i - 1} )} & ( 13 )\end{matrix}$$

Mₕᵢₑᵣ^{N}: Hierarchical Part-of-Speech N-Gram Model

$$\begin{matrix}P ( {w}_{i} \vert {t}_{i} ) = \frac{f ( {t}_{i}^{POS} {w}_{i} )}{f ( {t}_{i}^{POS} )} & ( 14 ) \\ P ( {t}_{i}^{form} \vert {t}_{i}^{POS} ) = \frac{f ( {t}_{i}^{POS} {t}_{i}^{form} )}{f ( {t}_{i}^{POS} )} & ( 15 ) \\ P ( {t}_{i}^{POS} \vert {t}_{i - N + 1} ⋯ {t}_{i - 1} ) = \frac{f ( {t}_{i - N + 1} ⋯ {t}_{i - 1} {t}_{i}^{POS} )}{f ( {t}_{i - N + 1} ⋯ {t}_{i - 1} )} & ( 16 )\end{matrix}$$

As described above, the part-of-speech n-gram model having memory length N−1 is expressed by equation (3). The terms P(wᵢ|tᵢ) and P(tᵢ|t_{i-N+1} . . . tᵢ₋₁) on the right side of equation (3) are the parameters given in equations (8) and (9). The three lexicalized part-of-speech n-gram models having memory length N−1 are expressed by equations (4), (5), and (6). The terms P(wᵢ|tᵢ), P(tᵢ|w_{i-N+1}t_{i-N+1} . . . wᵢ₋₁tᵢ₋₁), P(wᵢtᵢ|t_{i-N+1} . . . tᵢ₋₁), and P (wᵢtᵢ|w_{i-N+1}t_{i-N+1} . . . wᵢ₋₁tᵢ₋₁) appearing on the right sides of equations (4), (5), and (6) are the parameters in equations (10) to (13). The hierarchical part-of-speech n-gram model having memory length N−1 is expressed in equation (7). The terms P(wᵢ|tᵢ), P(tᵢ^{form}|tᵢ^{pos}), and P(tᵢ^{pos}|t_{i-N+1} . . . tᵢ₋₁) on the right side of equation (7) are the parameters in equations (14), (15), and (16).

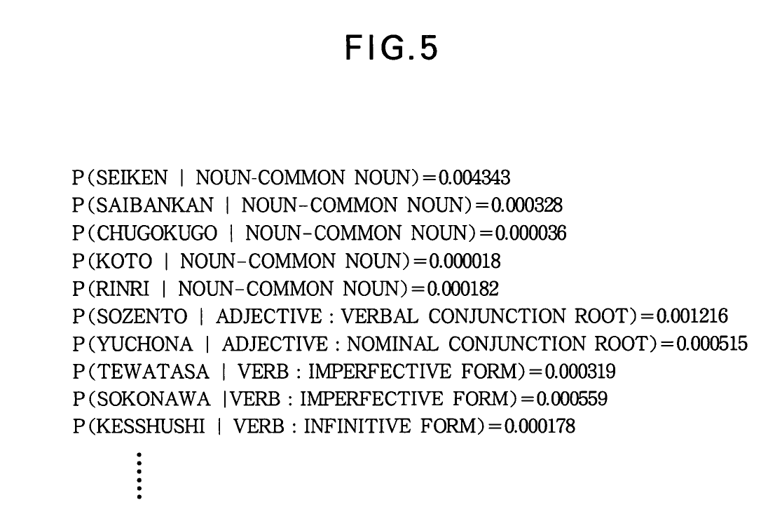

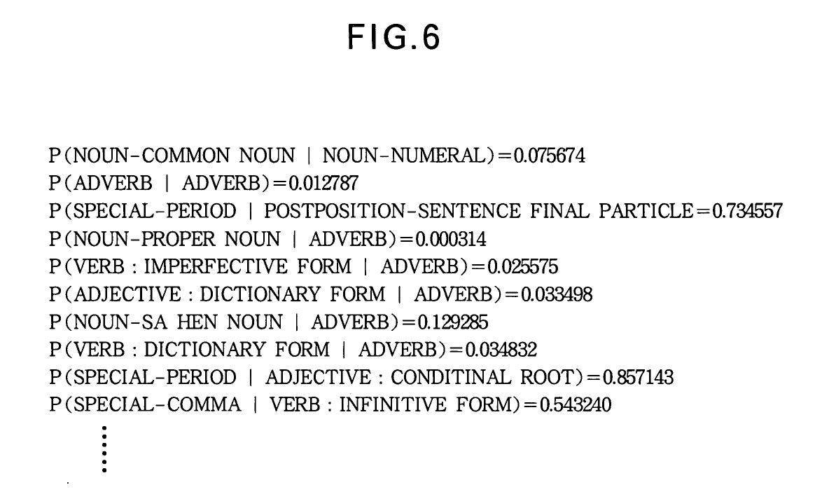

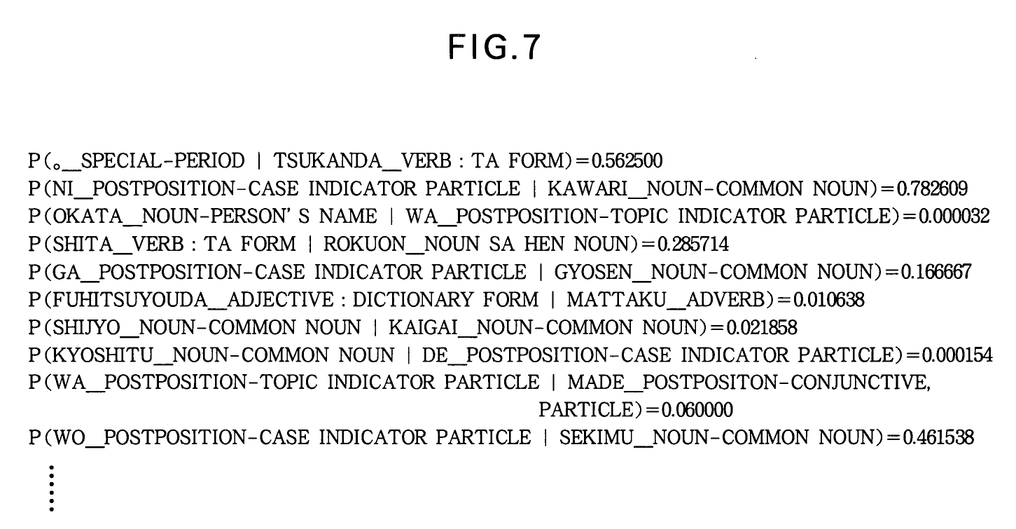

Each of the parameters is obtained by dividing the number of occurrences of a particular word string, part-of-speech string, or part-of-speech tag string or the like in the corpus by the number of occurrences of a more general word string, part-of-speech string, or part-of-speech tag string or the like. The values obtained by these division operations are stored in the stochastic model storage unit 122. FIGS. 5, 6, and 7 show some of the stochastic model parameters stored in the stochastic model storage unit 122.

Next, the weight calculation unit 133 calculates the weights of the stochastic models by using the part-of-speech tagged corpus stored in the part-of-speech tagged corpus storage unit 131 and the stochastic models stored in the stochastic model storage unit 122, and the weight calculation unit 133 stores the results in the weight storage unit 123 (302 in FIG. 3).

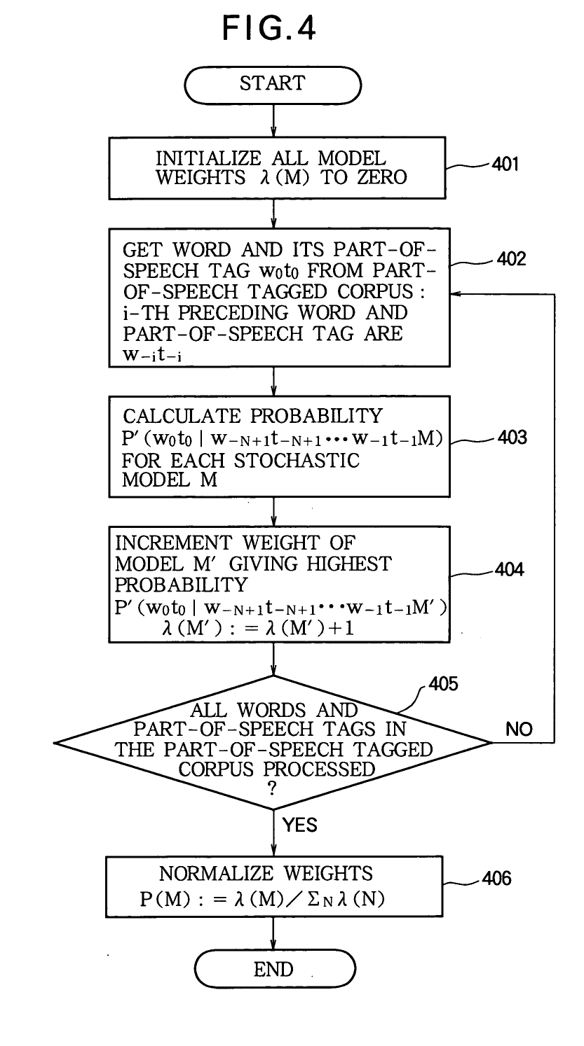

In the calculation of weights, an approximation is made that is independent of the word/part-of-speech tag string, as shown in equation (17) below. The calculation is performed in the steps shown in FIG. 4, using the leave-one-out method.

P(M|w₀t₀ . . . wᵢ₋₁tᵢ₋₁)≈P(M) (17)

First, an initialization step is performed, setting all the weight parameters λ(M) of the models M to zero (401). Next, a pair w₀t₀ consisting of a word and its part-of-speech tag is taken from the part-of-speech tagged corpus stored in the part-of-speech tagged corpus storage unit 131; the word and the part of speech in the (i)-th position forward of this pair are w₋ᵢ and t₋ᵢ (402). Next, the conditional probabilities P′(w₀t₀|w_{-N+1}t_{-N+}1 . . . w₋₁t₋₁M) of occurrence of the pair w₀t₀ are calculated for each model M (403).

The probability P′(X|Y)=P′(w₀t₀|w_{-N+1}t_{-N+1} . . . w₋₁t₋₁M is the value obtained by counting occurrences in the corpus, leaving the event now under consideration out of the count. This probability is calculated as in the following equation (18).

$${P}^{′} ( X \vert Y ) = \{ \begin{matrix}0 & ( f ( Y ) - 1 = 0 ) \\ \frac{f ( XY ) - 1}{f ( Y ) - 1} & otherwise .\end{matrix} \qquad ( 18 )$$

If the model M′ has the highest probability value among the probabilities calculated for the models as described above, the weight parameter λ(M′) of this model M′ is incremented by unity (404). When the processes performed in steps 402-404 have been repeated for all the pairs of words and part-of-speech tags in the part-of-speech tagged corpus (405), and the processing of all the pairs has been finished, the weights P(M) of the stochastic models M are normalized as shown in equation (19) below (406).

$$P ( M ) = \frac{λ ( M )}{{\sum }_{N}^{} λ ( N )} \qquad ( 19 )$$

Although an approximation is used for simplicity in the calculation of weights in equation (17) above, the weights can be calculated as in equation (1) by using a combination of the part-of-speech n-gram, the lexicalized n-gram, and the hierarchical part-of-speech n-gram and the like, instead of an approximation.

According to the first embodiment described above, the result with the maximum likelihood is selected from among a plurality of candidate results (hypotheses) of the morphological analysis obtained by using a morpheme dictionary. The probabilities of the hypotheses are calculated so as to select the result with the maximum likelihood by using information about parts of speech, lexicalized parts of speech, and hierarchical parts of speech. Accordingly, compared with methods in which the probabilities are calculated by using only information about parts of speech to select the hypothesis with the maximum likelihood, morphological analysis can be performed with a higher degree of accuracy, and ambiguity can be resolved.

### Second Embodiment

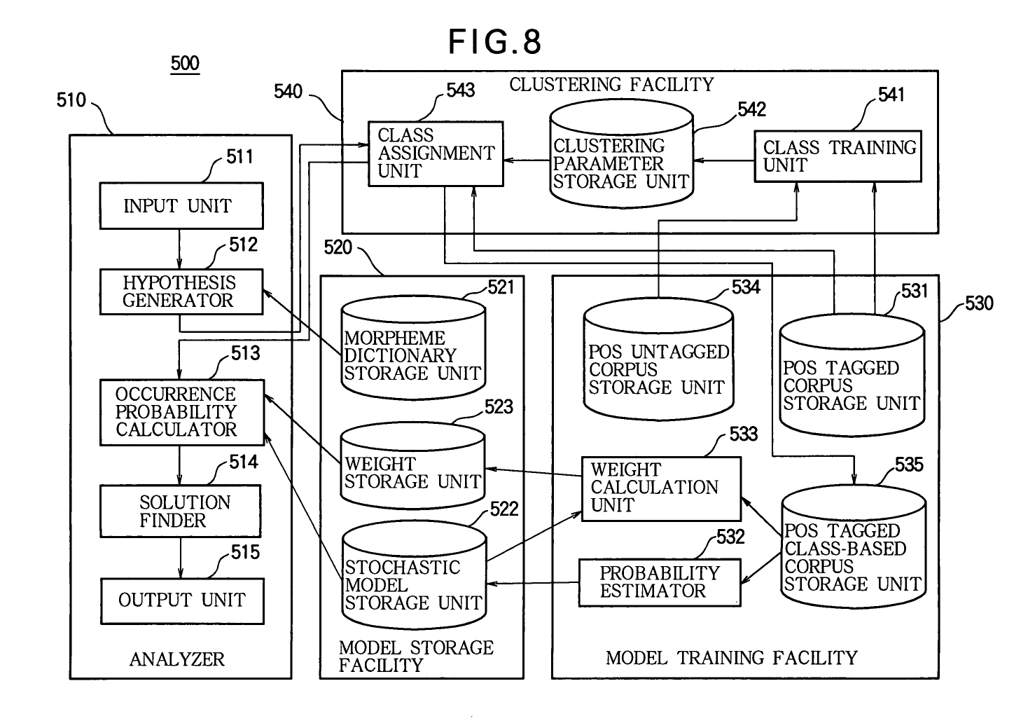

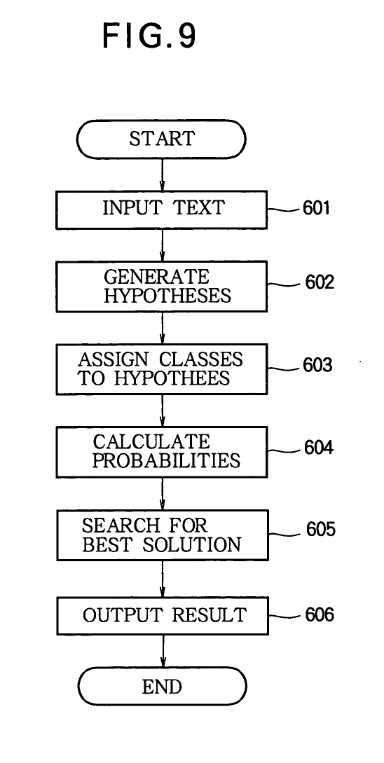

The second embodiment is a morphological analyzer that may be realized by, for example, installing a set of morphological analysis programs in an information processing device such as a personal computer. FIG. 8 shows a functional block diagram of the morphological analyzer. FIGS. 9, 10, and 11 illustrate the flow of the morphological analysis programs.

Referring to FIG. 8, the morphological analyzer 500 in the second embodiment differs from the morphological analyzer 100 in the first embodiment by including a clustering facility 540 and a different model training facility 530. The model training facility 530 differs from the model training facility 130 in the first embodiment by including a part-of-speech untagged corpus storage unit 534 and a part-of-speech tagged class-based corpus storage unit 535.

The clustering facility 540 comprises a class training unit 541, a clustering parameter storage unit 542, and a class assignment unit 543.

The class training unit 541 trains classes by using a part-of-speech tagged corpus stored in the part-of-speech tagged corpus storage unit 531 and a part-of-speech untagged corpus stored in the part-of-speech untagged corpus storage unit 534, and stores the clustering parameters obtained as the result of training in the clustering parameter storage unit 542.

The class assignment unit 543 inputs the part-of-speech tagged corpus in the part-of-speech tagged corpus storage unit 531, assigns classes to the part-of-speech tagged corpus by using the clustering parameters stored in the clustering parameter storage unit 542, and stores the part-of-speech tagged corpus with assigned classes in the part-of-speech tagged class-based corpus storage unit 535; the class assignment unit 543 also receives the hypotheses obtained in the hypothesis generator 512, finds the classes to which the words in the hypotheses belong, and outputs the hypotheses with this class information to the occurrence probability calculator 513.

The probability estimator 532 and the weight calculation unit 533 use the part-of-speech tagged class-based corpus stored in the part-of-speech tagged class-based corpus storage unit 535.

Next, the operation (morphological analysis method) of the morphological analyzer 500 in the second embodiment will be described with reference to the flowchart in FIG. 9. FIG. 9 illustrates the procedure by which the morphological analyzer 500 performs morphological analysis on an input text and outputs a result. Since the morphological analyzer 500 in the second embodiment differs from the morphological analyzer 100 in the first embodiment only by using class information in the calculation of probabilities, only the differences from the first embodiment will be described below.

After input of the source text (601) and generation of hypotheses (602), the generated hypotheses are input to the class assignment unit 543, where classes are assigned to the words in the hypotheses. The hypotheses and their assigned classes are supplied to the occurrence probability calculator 513 (603). The method of assigning classes to the hypotheses will be explained below.

Next, probabilities are calculated for the hypotheses, to which the classes are assigned, in the occurrence probability calculator 513 (604). To calculate the probabilities of the hypotheses, stochastically weighted part-of-speech n-grams, lexicalized part-of-speech n-grams, hierarchical part-of-speech n-grams, and class part-of-speech n-grams are used. Although the calculation method is expressed in equation (1) above, the set of models M is, the set expressed by the roman letter M in equation (20), instead of equation (2). The probabilities P (M) of the constituent models in the set M sum to unity, as shown in equation (20.5).

$$\begin{matrix}M = \{ {M}_{POS}^{1} , ⋯ , {M}_{POS}^{{N}_{POS}} , {M}_{lex1}^{1} , ⋯ , {M}_{lex1}^{{N}_{lex1}} , {M}_{lex2}^{1} , ⋯ , {M}_{lex2}^{{N}_{lex2}} , {M}_{lex3}^{1} , ⋯ , {M}_{lex3}^{{N}_{lex3}} , {M}_{hier}^{1} , ⋯ , {M}_{hier}^{{N}_{hier}} , {M}_{class1}^{1} , ⋯ , {M}_{class1}^{{N}_{class1}} , {M}_{class2}^{1} , ⋯ , {M}_{class2}^{{N}_{class2}} \} & ( 20 ) \\ {\sum }_{M ∈ M}^{} P ( M ) = 1 & ( 20.5 )\end{matrix}$$

As is evident from equations (2) and (20), the second embodiment uses all the models used in the first embodiment, with the addition of first and second class part-of-speech n-gram models. In equation (20), the subscript parameter class1 indicates the first class part-of-speech n-gram model, and the subscript parameter class2 indicates the second class part-of-speech n-gram model.

M_{class1}^{N}, M_{class2}^{N}: Class Part-of-Speech N-Gram Model

P(wᵢtᵢ|w₀t₀ . . . wᵢ₋₁tᵢ₋₁M_{class1}^{N})≡P(wᵢ|tᵢ)P(tᵢ|c_{i-N+1}t_{i-N+1} . . . cᵢ₋₁tᵢ₋₁) (21)

P(wᵢtᵢ|w₀t₀ . . . wᵢ₋₁tᵢ₋₁M_{class2}^{N})≡P(wᵢtᵢ|c_{i-N+1}t_{i-N+1} . . . cᵢ₋₁tᵢ₋₁) (22)

The first class part-of-speech n-gram model with memory length N−1 is defined in equation (21); the second class part-of-speech n-gram model with memory length N−1 is defined in equation (22).

The first class part-of-speech n-gram model with memory length N−1 calculates the product of the conditional probability P(wᵢ|tᵢ) of occurrence of the word wᵢ, given its part-of-speech tag tᵢ, and the conditional probability P(tᵢ|c_{i-N+1}t_{i-N+1} . . . cᵢ₋₁tᵢ₋₁) of occurrence of this part-of-speech tag tᵢ following the class and part-of-speech tag string c_{i-N+1}t_{i-N+1} . . . cᵢ₋₁tᵢ₋₁ of the preceding N−1 words.

The second class part-of-speech n-gram model with memory length N−1 calculates the conditional probability P(wᵢtᵢ|w_{i-N+1}t_{i-N+1} . . . wᵢ₋₁tᵢ₋₁) of occurrence of the combination wᵢtᵢ of the word wᵢ and its part-of-speech tag tᵢ following the class/part-of-speech tag string c_{i-N+1}t_{i-N+1} . . . cᵢ₋₁tᵢ₋₁ of the preceding N−1 words.

Since the probabilities of words are predicted by using these classes, the probabilities of hypotheses can be calculated by using both information about parts of speech and lexicalized parts of speech and class information. Although morphological analysis methods using classes are already known, since the morphological analyzer 500 stochastically weights, combines, and uses the stochastic models of the class part-of-speech n-grams and other stochastic models, as described above, the use of classes in the morphological analyzer 500 causes relatively few side effects such as lowered accuracy.

After the calculation of the probabilities by the stochastic models for the hypotheses, the best solution is found (605), and a result is output (606), as described above.

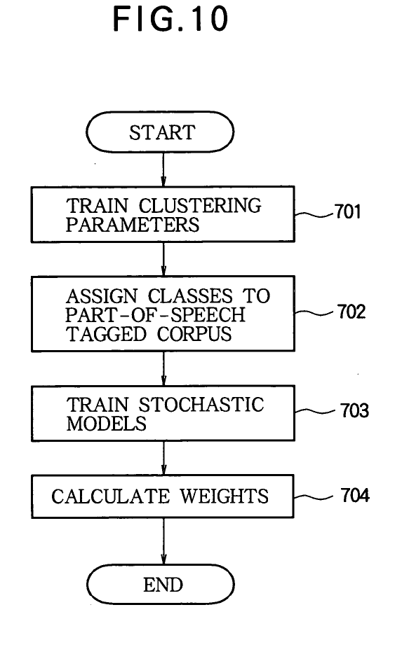

FIG. 10 is a flowchart illustrating the process for finding the stochastic models used in the occurrence probability calculator 513 described above and the weights of the stochastic models, by using the pre-provided part-of-speech tagged corpus and the part-of-speech untagged corpus.

The class training unit 541 obtains clustering parameters from the part-of-speech tagged corpus stored in the part-of-speech tagged corpus storage unit 531 and the part-of-speech untagged corpus stored in the part-of-speech untagged corpus storage unit 534, and stores the clustering parameters in the clustering parameter storage unit 542 (701).

In this clustering step, words are assigned to classes by using only the word information in the corpus. Accordingly, not only a hard-to-generate part-of-speech tagged corpus but also a readily available part-of-speech untagged corpus can be used for training clustering parameters. Hidden Markov models can be used as one method of clustering. In this case, the parameters can be acquired by use of the Baum-Welch algorithm. The processes of training hidden Markov models and assigning classes to words are discussed in detail in, for example, L. Rabiner and B-H. Juang, Fundamentals of Speech Recognition, Prentice Hall, 1993.

Next, the class assignment unit 543 receives the part-of-speech tagged corpus stored in the part-of-speech tagged corpus storage unit 531, performs clustering of the words, assigns classes to the part-of-speech tagged corpus by using the clustering parameters in the clustering parameter storage unit 542, and stores the part-of-speech tagged corpus with assigned classes in the part-of-speech tagged class-based corpus storage unit 535 (702). Next, the probability estimator 532 trains the parameters of the stochastic models (703).

The parameters for the stochastic models other than the class part-of-speech n-gram models are trained as in the first embodiment. If X is a string such as a word string, a part-of-speech tag string, or a class/part-of-speech tag string, and if f(X) indicates the number of occurrences of the string X in the corpus stored in the part-of-speech tagged class-based corpus storage unit 535, the parameters for the class part-of-speech n-gram models are expressed in equations (23) to (25) below.

M_{class1}^{N}, M_{class2}^{N}: Class Part-of-Speech N-Gram Model

$$\begin{matrix}P ( {w}_{i} \vert {t}_{i} ) = \frac{f ( {t}_{i} {w}_{i} )}{f ( {t}_{i} )} & ( 23 ) \\ P ( {t}_{i} \vert {c}_{i - N + 1} {t}_{i - N + 1} ⋯ {c}_{i - 1} {t}_{i - 1} ) = \frac{f ( {c}_{i - N + 1} {t}_{i - N + 1} ⋯ {c}_{i - 1} {t}_{i - 1} {t}_{i} )}{f ( {c}_{i - N + 1} {t}_{i - N + 1} ⋯ {c}_{i - 1} {t}_{i - 1} )} & ( 24 ) \\ P ( {w}_{i} {t}_{i} \vert {c}_{i - N + 1} {t}_{i - N + 1} ⋯ {c}_{i - 1} {t}_{i - 1} ) = \frac{f ( {c}_{i - N + 1} {t}_{i - N + 1} ⋯ {c}_{i - 1} {t}_{i - 1} {w}_{i} {t}_{i} )}{f ( {c}_{i - N + 1} {t}_{i - N + 1} ⋯ {c}_{i - 1} {t}_{i - 1} )} & ( 25 )\end{matrix}$$

The first and second class part-of-speech n-gram models with memory length N−1 are expressed by equations (21) and (22), as described above. The terms P(wᵢ|tᵢ), P(tᵢ|c_{i-N+1}t_{i-N+1} . . . cᵢ₋₁tᵢ₋₁), and P(wᵢtᵢ|c_{i-N+1}t_{i-N+1} . . . cᵢ₋₁tᵢ₋₁) on the right side of equations (21) and (22) are the parameters in equations (23), (24), and (25).

After the stochastic model parameters have been stored in the stochastic model storage unit 522, the weight calculation unit 533 calculates the weights of the stochastic models and stores the results in the weight storage unit 523 (704).

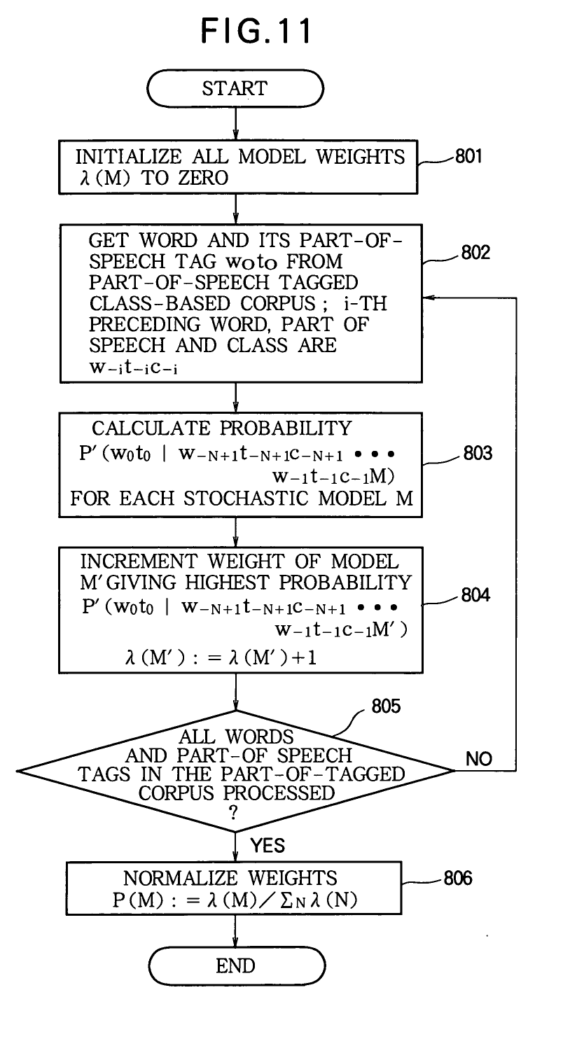

The calculation of weights is performed in the steps shown in the flowchart in FIG. 11. Steps 801, 802, 803, 804, 805, and 806 are analogous to steps 401, 402, 403, 404, 405, and 406 in the second embodiment. Since the calculation of weights in the second embodiment differs from the calculation of weights in the first embodiment (see FIG. 4) only by using the part-of-speech tagged class-based corpus stored in the part-of-speech tagged class-based corpus storage unit 535, instead of the part-of-speech tagged corpus stored in the part-of-speech tagged corpus storage unit 131, and using class part-of-speech n-grams in addition to part-of-speech n-grams, lexicalized part-of-speech n-grams, and hierarchical part-of-speech n-grams as the stochastic models, a detailed description of the calculation procedure will be omitted.

According to the second embodiment described above, the result with the maximum likelihood is selected from among a plurality of results (hypotheses) of morphological analysis obtained by using a morpheme dictionary. Since information on classes assigned to the hypotheses according to clustering is also used, information more detailed than part-of-speech information, but on a higher level of abstraction than the information in the lexicalized part-of-speech models, can also be used, so morphological analysis can be performed with a higher degree of accuracy than in the first embodiment. Since the clustering accuracy is increased by using part-of-speech untagged data, the accuracy of the results of morphological analysis is also increased.

In the first embodiment, the probabilities of hypotheses are found by using a part-of-speech n-gram stochastic model, lexicalized part-of-speech n-gram stochastic models, and a hierarchical part-of-speech n-gram stochastic model. In the second embodiment, the probabilities of hypotheses are found by using the part-of-speech n-gram stochastic model, the lexicalized part-of-speech n-gram stochastic models, the hierarchical part-of-speech n-gram stochastic model, and class part-of-speech n-gram stochastic models. The combination of stochastic models used in the invention is not restricted to the combinations used in the embodiments described above, however, provided a part-of-speech n-gram stochastic model including information on forms of parts of speech is included in the combination.

The method used by the hypotheses generators 112 and 512 for generating hypotheses (candidate results of the morphological analysis) is not restricted to general morphological analysis methods using a morpheme dictionary; other morphological analysis methods, such as methods using character n-grams, may also be used.

Although the embodiments above simply output the hypothesis with the maximum likelihood as the result of the morphological analysis, the result obtained from the morphological analysis may also be immediately supplied to a natural language processor such as a machine translation system.

Furthermore, although the morphological analyzers in the embodiments above include a model training facility and, in the second embodiment, a clustering facility, the morphological analyzer need only include an analyzer and a model storage facility. The model training facility and clustering facility may be omitted, if the information stored in the model storage unit is generated by a separate model training facility and clustering facility in advance. If the morphological analyzer in the second embodiment does not have a clustering facility or the equivalent, the model storage unit must have a function for assigning classes to hypotheses.

The corpus used in the various processes may be taken from a network or the like by communication processing.

The language to which the invention can be applied are restricted to the Japanese language mentioned in the description above.

Those skilled in the art will recognize that further variations are possible within the scope of the invention, which is defined in the appended claims.

What is claimed is:

1. A morphological analyzer comprising:
a hypothesis generator for applying a prescribed method of morphological analysis to a text and generating one or more hypotheses as candidate results of the morphological analysis, each hypothesis being a word string with part-of-speech tags, the part-of-speech tags including form information for parts of speech having forms;
a model storage facility storing information for a plurality of part-of-speech n-gram models, at least one of the part-of-speech n-gram models including information about the forms of the parts of speech;
a probability calculator for finding a probability that each said hypothesis will appear in a large corpus of text by using a weighted combination of the information for the part-of-speech n-gram models stored in the model storage facility; and
a solution finder for finding a solution among said hypotheses, based on the probabilities generated by the probability calculator.

2. The morphological analyzer of claim 1, wherein said at least one of the part-of-speech n-gram models including information about forms of parts of speech is a hierarchical part-of-speech n-gram model.

3. The morphological analyzer of claim 2, wherein the hierarchical part-of-speech n-gram model calculates a product of a conditional probability P(wᵢ|tᵢ) of occurrence of a word wᵢ given its part of speech tᵢ, a conditional probability P(tᵢ^{form}|tᵢ^{pos}) of occurrence of the part of speech tᵢ^{pos} of said word wᵢ in a form tᵢ^{form} shown by said word wᵢ, and a conditional probability P(tᵢ^{pos}|t_{i-N+1} . . . tᵢ₋₁) of occurrence of the part of speech tᵢ^{pos} of said word wᵢ following a part-of-speech tag string t_{i-N+1} . . . tᵢ₋₁ indicating parts of speech of N−1 preceding words, where N is a positive integer.

4. The morphological analyzer of claim 1, wherein at least one of the part-of-speech n-gram models is a lexicalized part-of-speech n-gram model.

5. The morphological analyzer of claim 4, wherein the lexicalized part-of-speech n-gram model calculates a product of a conditional probability P(wᵢ|tᵢ) of occurrence of a word wᵢ given its part of speech tᵢ and a conditional probability P(tᵢ|w_{i-N+1}t_{i-N+1} . . . wᵢ₋₁tᵢ₋₁) of occurrence of the part of speech tᵢ of said word wᵢ following N−1 words w_{i-N+1} . . . wᵢ₋₁ having respective parts of speech t_{i-N+1} . . . tᵢ₋₁, where N is a positive integer.

6. The morphological analyzer of claim 4, wherein the lexicalized part-of-speech n-gram model calculates a conditional probability P(wᵢtᵢ|t_{i-N+1} . . . tᵢ₋₁) of occurrence of a word wᵢ having a part of speech tᵢ following a string of N−1 parts of speech t_{i-N+1} . . . tᵢ₋₁, where N is a positive integer.

7. The morphological analyzer of claim 4, wherein the lexicalized part-of-speech n-gram model calculates a conditional probability P(wᵢtᵢ|w_{i-N+1}t_{i-N+1} . . . wᵢ₋₁tᵢ₋₁) of occurrence of a word wᵢ having a part of speech tᵢ following a string of N−1 words w_{i-N+1} . . . wᵢ₋₁ having respective parts of speech t_{i-N+1} . . . tᵢ₋₁, where N is a positive integer.

8. The morphological analyzer of claim 1, wherein at least one of the part-of-speech n-gram models stored in the model storage facility is a class part-of-speech n-gram model.

9. The morphological analyzer of claim 8, wherein the class part-of-speech n-gram model calculates a product of a conditional probability P(wᵢ|tᵢ) of occurrence of a word wᵢ given its part of speech tᵢ and a conditional probability P(tᵢ|c_{i-N+1}t_{i-N+1} . . . cᵢ₋₁tᵢ₋₁) of occurrence of said part of speech tᵢ following a string of N−1 words assigned to respective classes c_{i-N+1} . . . cᵢ₋₁ with respective parts of speech t_{i-N+1} . . . tᵢ₋₁, where N is a positive integer.

10. The morphological analyzer of claim 8, wherein the class part-of-speech n-gram model calculates a product of a conditional probability P(wᵢtᵢ|c_{i-N+1}t_{i-N+1} . . . cᵢ₋₁tᵢ₋₁) of occurrence of a word wᵢ having a part of speech tᵢ following a string of N−1 words in respective classes c_{i-N+1} . . . cᵢ₋₁ with respective parts of speech t_{i-N+1} . . . tᵢ₋₁, where N is a positive integer.

11. The morphological analyzer of claim 8, wherein the class part-of-speech n-gram model is trained from both a part-of-speech tagged corpus and a part-of-speech untagged corpus.

12. The morphological analyzer of claim 1, further comprising a weight calculation unit using a leave-one-out method to calculate weights of the part-of-speech n-gram models.

13. A method of morphological analysis comprising:
applying a prescribed method of morphological analysis to a text and generating one or more hypotheses as candidate results of the morphological analysis, each hypothesis being a word string with part-of-speech tags, the part-of-speech tags including form information for parts of speech having forms;
calculating probabilities that each said hypothesis will appear in a large corpus of text by using a weighted combination of a plurality of part-of-speech n-gram models, at least one of the part-of-speech n-gram models including information about forms of parts of speech; and
finding a solution among said hypotheses, based on said probabilities.

14. The method of claim 13, wherein said at least one of the part-of-speech n-gram models including information about forms of parts of speech is a hierarchical part-of-speech n-gram model.

15. The method of claim 14, wherein the hierarchical part-of-speech n-gram model calculates a product of a conditional probability P(wᵢ|tᵢ) of occurrence of a word wᵢ given its part of speech tᵢ, a conditional probability P(tᵢ^{form}|tᵢ^{pos}) of occurrence of the part of speech tᵢ^{pos} of said word wᵢ in a form tᵢ^{form} shown by said word wᵢ, and a conditional probability P(tᵢ^{pos}|t_{i-N+1} . . . tᵢ₋₁) of occurrence of the part of speech tᵢ^{pos} of said word wᵢ following a part-of-speech tag string t_{i-N+1} . . . tᵢ₋₁ indicating parts of speech of N−1 preceding words, where N is a positive integer.

16. The method of claim 13, wherein at least one of the part-of-speech n-gram models is a lexicalized part-of-speech n-gram model.

17. The method of claim 13, wherein at least one of the part-of-speech n-gram models is a class part-of-speech n-gram model.

18. The method of claim 17, further comprising training the class part-of-speech n-gram model from both a part-of-speech tagged corpus and a part-of-speech untagged corpus.

19. The method of claim 13, further comprising using a leave-one-out method to calculate weights of the part-of-speech n-gram models.

20. A machine-readable medium storing a program comprising instructions that can be executed by a computing device to carry out morphological analysis by the method of claim 13.
